(19) United States
(12) Patent Application Publication
(10) Pub. No.: US 2007/0210192 A1
(43) Pub. Date: Sep. 13, 2007

(54) Fire Fighting Apparatus For Road And Railway Tunnels

(76) Inventor: Domenico Piatti, Pomlglian d'Arco (IT)

Correspondence Address: YOUNG & THOMPSON, 745 SOUTH 23RD STREET, 2ND FLOOR, ARLINGTON, VA, 22202, US

(21) Appl. No.: 11/587,356

(22) PCT Filed: May 3, 2005
(86) PCT No.: PCT/IT05/00252

§ 371 Date: Oct. 24, 2006

(30) Foreign Application Priority Data
May 7, 2004 (IT) NA2004A000024

(51) Int. Cl. B05B 3/18; A62C 27/00

(52) U.S. Cl. 239/750; 169/55; 169/70; 169/52

(57) ABSTRACT

A fire fighting apparatus for road and railway tunnels consisting of a remote controlled vehicle which is provided with a thermal water-cooled shield and is allowed to run along a monorail secured to the tunnel and acting also as water pipe to extinguish fire. The vehicle carries also a telescopically extensible hose that can be connected to the monorail in case of fire to draw water off. This hose is able to direct the waterjet to the positions of the fire centres located by a suitable camera.

Fire in road and railway tunnels are hardly manageable and cause very often many casualties because of the smoke stagnation.

The problem arisen is that the development of fire inside a tunnel leads quickly to a considerable increase in the temperature which can exceed 1000° C. Therefore, it is difficult to reach the fire centre with fire extinguishing means and impossible for fireman squads to get near the fire.

Several systems have been envisaged to solve the problem including remote controlled means carrying fire extinguishing equipment or a relief expedition of firemen wearing particular overalls on board of transport means provided with special heat-resistant shields.

The same Applicant of the present patent application proposed and patented a robot moving on a rail which is cooled inside with very good results.

Starting from the preceding patent, the present industrial invention aims at providing a means that gives a new solution for a more efficient use.

The apparatus of the present invention is shown in the accompanying drawings.

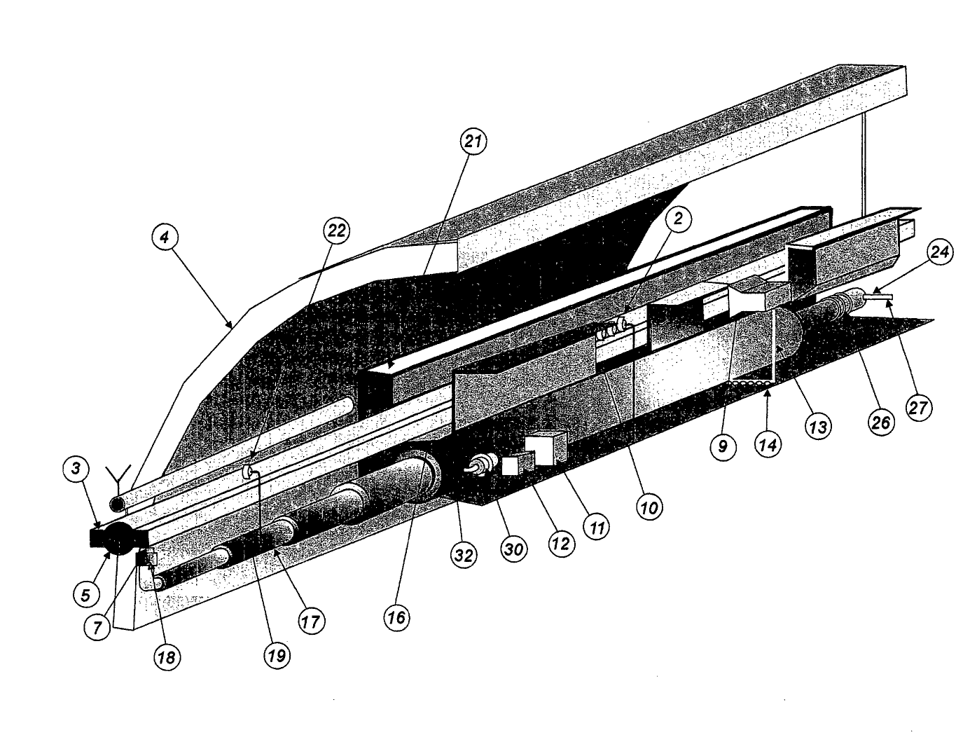

FIG. 1 of table 1/5 shows an axonometric view.

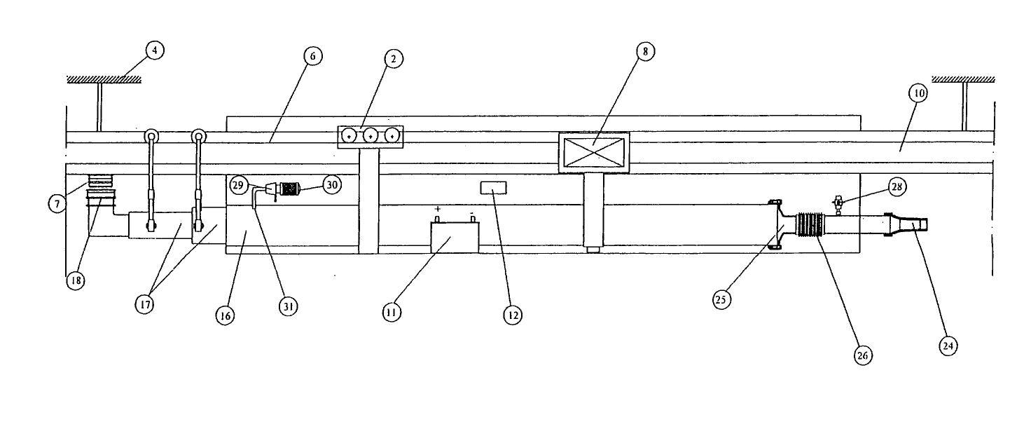

FIG. 2 of table 2/5 shows a longitudinal side view.

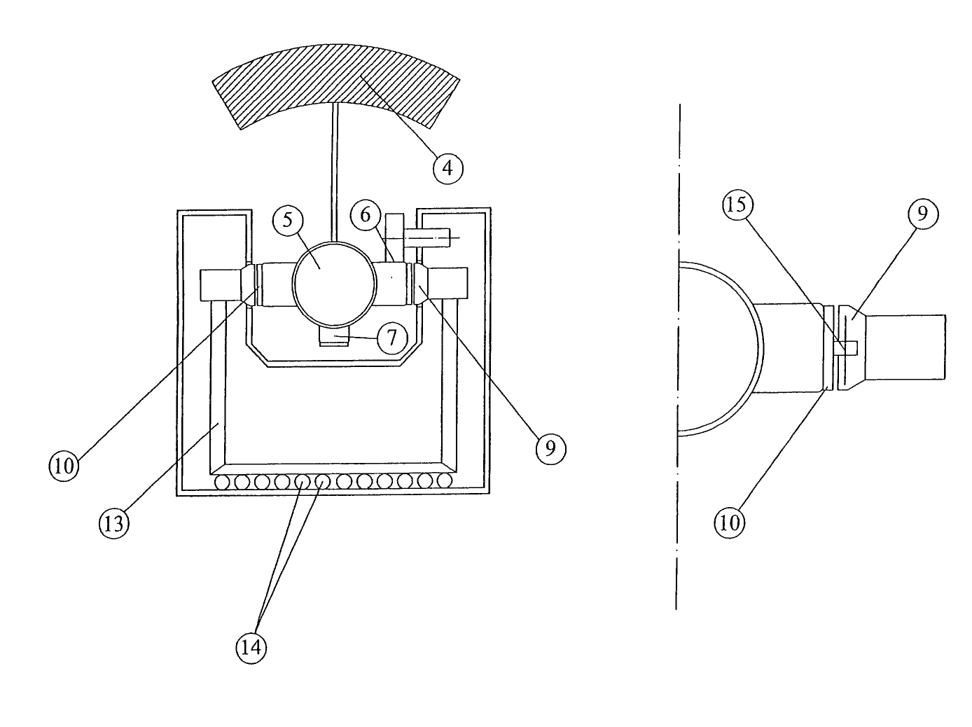

FIG. 3 of table 3/5 shows a cross sectional view of the motors of the apparatus, and FIG. 3a shows a detail of the limit stops.

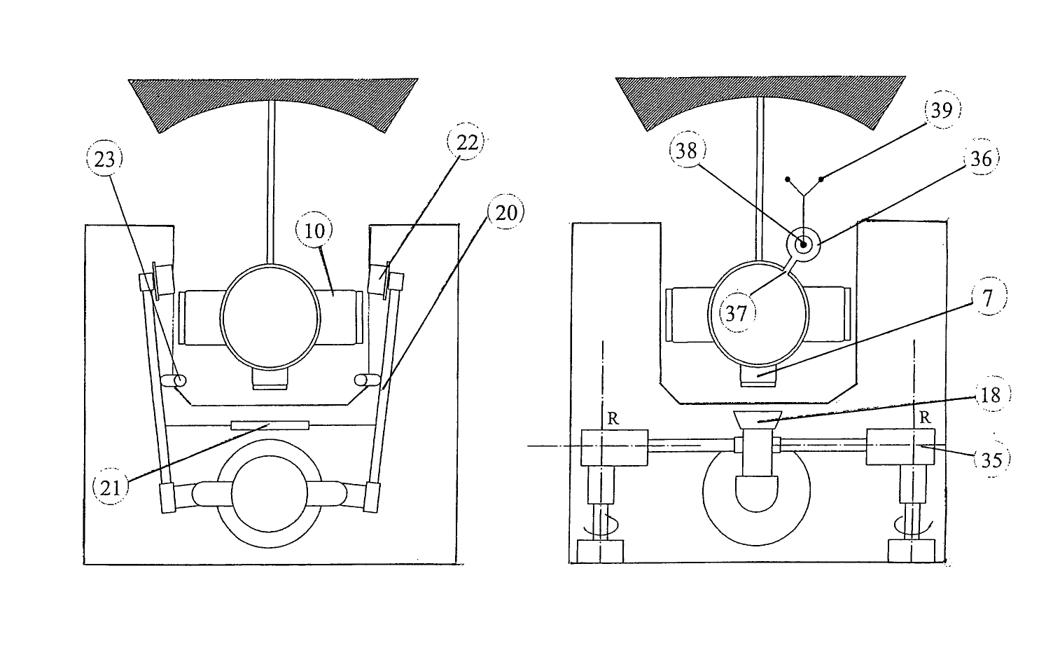

FIG. 4 of table 4/5 shows a cross sectional view of the brackets of the telescopic hose, and FIG. 4a shows the section view of a hydraulic coupling device.

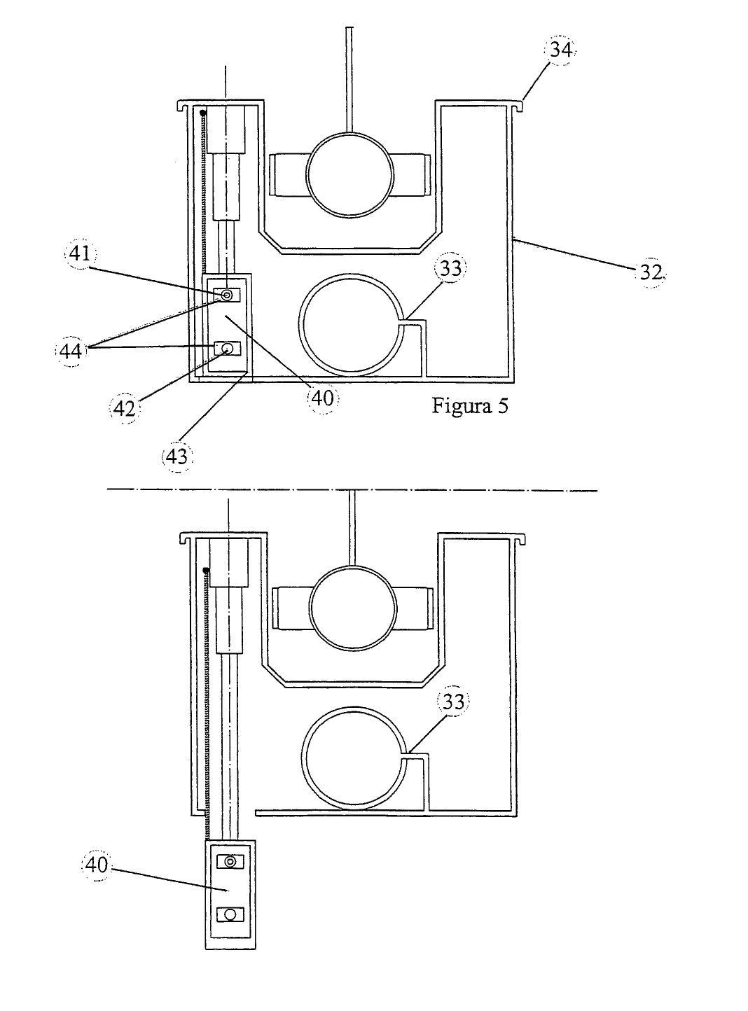

FIG. 5 of table 5/5 shows a cross sectional view of the thermal shield, and FIG. 5a shows the cross sectional vies of the periscope.

With reference to the figures the apparatus consists of vehicle 1 with one ore more trolleys 2 that slides on a monorail 3 secured to the vault or the wall of a tunnel 4.

The monorail includes a pipe 5 feeding the fire-extinguishing water and cooling runways 6.

Water plugs 7 are provided in the pipe for the connection of the apparatus when the latter reaches the fire centre in the tunnel.

Water or an anti-fire foaming solution is fed from the outside of the tunnel through a pumping system.

The apparatus is driven by linear magnetic motors 8 the inductors 9 of which are on board of the vehicle and the armature is formed by surface 10 of runway 6. The magnetic motors are energised by accumulators 11 through inverter 12.

Each motor consists of a couple of opposed inductors 9 located on a trolley 13 provided with rollers 14 allowing it to move crosswise along the curves.

Wheels 15 are limit stops and prevent inductors 9 from attaching to armature 10 and braking the vehicle.

The vehicle is provided with a telescopic hose formed by a conduit 16 secured to the chassis and including a number of pipes 17 coaxial to one another.

Placed at the end of the last pipe is a valve 18 which is connected to water plug 7 of monorail.

Each pipe of the telescopic hose carries at its end a bracket 19 consisting of two rods 20 hinged to the conduit and biased by a spring 21.

Each rod is provided at its end with a small wheel 22.

When the hose is retracted, cams 23 keep rods 20 open, and small wheels 22 do not touch the rail.

When valve 10 is connected to water plug 7 (FIG. 1) and the vehicle is moving, pipes 17 of the telescopic hose are extracted and the rods are not in touch with the cams any longer and approach each other so that the small wheels rest on the rail and bear the hose.

Because of the coupling between vehicle and rail, the fire-extinguishing water under pressure in the conduit of the rail flows into the hose and from the latter directly into the anti-fire nozzle 24.

Anti-fire nozzle 24 consists of a portion of rigid pipe 25 and a portion of flexible pipe 26.

Hydraulic cylinders 27 and 28 can cause it to turn so that the water jet can be oriented horizontally and vertically.

The vehicle is provided with a small water turbine 29 connected to a hydraulic generator 30 and operated by pressurised water from the monorail through a plug 31 located at the stationary portion of the telescopic hose.

As the hydraulic generator is operated by the fire-extinguishing water, it is an unlimited energy source to charge the accumulator so that the fire fighting operation can be prolonged in time.

The vehicle is protected outwardly by a double-wall carter 32 in which part of the fire-extinguishing water from the monorail is circulated through a water plug 33 placed at the stationary portion of the telescopic hose. The carter is provided with overflow pipes 34 from which water overflows and laps the walls of the carter, thus providing a further cooling of the outside walls most exposed to fire.

Located at the rear portion of the vehicle is a mechanical or oleodynamic device 35 that causes the cylinders to return after having connected valve 18 to water plug 7 and rotates about its axis R to allow telescopic hose 17 with its brackets 19 to travel.

The monorail is provided with a cooled pipeline 36 consisting of a double-wall conduit running parallel to the rail so that the fire-extinguishing water drawn off from the rail through water plugs 37 flows in the hollow space between the two walls.

A cable 38 for the transmission of radio and television signals by antennas 39 is laid inside pipeline 36 protected from fire by water circulating in the hollow space between the two walls.

The vehicle is provided with a periscope 40 equipped with thermal camera 41 and camera 42 that come out of the carter and are lowered to a lower level than the vehicle to shoot the imagines of the smoke layer which is stagnant at the vault.

The periscope is surrounded by a double-wall carter 43 in which the fire-extinguishing water circulates to cool the electronic apparatus.

The periscope is provided with two motorised sash doors 44 placed in front of the objectives of the thermal camera and the camera that open at predetermined moments to shoot the imagines and close in case of high temperature so that the cameras are not damaged.

The vehicle is equipped with a board computer, radio set, megaphone to communicate with the outside, and beacon.

The apparatus can be driven from the outside of the tunnel by the above-mentioned radio transmitting device, with antennas 39 being installed directly to the rail and connected to the cooled pipeline 36.

However, the system can be completely automated due to a thermal camera 41 on board which allows the fire centres to be located and the anti-fire nozzle 24 to be directed thereto.

Shape and structure modifications of the proposed apparatus can be made within the scope of the inventive concept which is defined by the appended claims.

1. A fire fighting apparatus for road and railway tunnels which is remote controlled or operated by a robot and consisting of a vehicle with a thermal water shield which is driven by linear magnetic motors and slides on a monorail secured to the vault of the tunnel to reach the fire centre, said monorail being also used as conduit for fire-extinguishing water, said vehicle being provided with a telescopic hose able to be connected automatically to the monorail at the fire location to draw off water and to direct the water jet to the fire centres located by a camera or an infrared thermal camera.

2. The apparatus of claim 1, characterized in that the monorail includes a conduit to convey the fire-extinguishing water that cools automatically the runway.

3. The apparatus of claim 1, characterized in that water plugs are provided along the monorail to which the robot is automatically connected.

4. The apparatus of claim 1, characterized in that the vehicle is driven by linear magnetic motors provided with two opposed inductors secured to a support that slides crosswise on rollers allowing the air space along the curves of the monorail to be regulated automatically.

5. The apparatus of claim 1, characterized in that the linear magnetic motors are provided with a pair of front small wheels which prevent the inductor from attaching to rail.

6. The device of claim 1, characterized in that it is provided with a telescopic fire-extinguishing hose equipped with brackets provided with small wheels that in case of fire close automatically to the runway of the monorail by means of return springs between rods and cams fixed to the frame.

7. The apparatus of claim 1, characterized in that it is provided with a water turbine operated by the fire-extinguishing water drawn off from the monorail and able to charge the accumulators by an electric generator.

8. The apparatus of claim 1, characterized in that it is provided with a thermal shield consisting of an outside carter having an air space for the circulation of the fire-extinguishing water that is drawn off from the monorail and discharged to the outside onto the walls of the carter.

9. The apparatus of the claim 1, characterized by an anti-fire nozzle having a flexible coupling along the pipe which allows it to be oriented by deformation under the force developed by known oleodynamic or mechanical devices.

10. The apparatus of claim 1, characterized in that a device placed at the end portion of the apparatus provides for the hydraulic coupling to the monorail and then opens to allow the telescopic hose with its brackets to be extracted.

11. The apparatus of the claim 1, characterized by a periscope equipped with a camera and a thermal camera that come out of the carter and are lowered at a lower level than the vehicle to shoot the images of the smoke layer which is stagnant under the vault.

12. The apparatus of claim 11, characterized in that the periscope is cooled by the fire-extinguishing water that circulates in the air space of the outside carter.

13. The apparatus of claim 1, characterized in that the periscope has a window that opens to allow the thermal camera to shoot the images, and closes to prevent the thermal camera from being damaged as the outside temperature is high.

14. The apparatus of claim 1, characterized in that it is equipped with a board computer which processes the shooting of the burning objects from the cameras and thermal cameras in different locations of the tunnel, and calculates the coordinates to direct the water jets of the anti-fire nozzle to fire.

15. The apparatus of claim 1, characterized in that it can travel over the fire area by an alternate movement, owing to the telescopic hose with which it is provided, and sprinkle all the road by a water jet so as to hit the fire centres.

16. The apparatus of claim 1, characterized in that it has a cooled conduit including a cable for the transmission of signals and consisting of a double-wall pipe for the circulation of the fire-extinguishing water drawn off directly from the monorail.
